(19) United States
(12) Patent Application Publication
(10) Pub. No.: US 2022/0381697 A1
(43) Pub. Date: Dec. 1, 2022

(54) SYSTEM AND METHODS FOR ANALYZING BIOSENSOR TEST RESULTS

(71) Applicant: Carbon Holdings Intellectual Properties, LLC, Lexington, KY (US)

(72) Inventors: Charles Agee Atkins, Sheridan, WY (US); Garrett W. Lindemann, Buffalo, WY (US)

(21) Appl. No.: 17/827,268

(22) Filed: May 27, 2022

Related U.S. Application Data
(60) Provisional application No. 63/194,794, filed on May 28, 2021.

(51) Int. Cl. G01N 21/65; G01N 15/14; G01J 3/44; G06T 7/30; G06V 20/69

(52) U.S. Cl. CPC G01N 21/65; G01N 15/1475; G01J 3/44; G06T 7/30; G06V 20/693; G06V 20/698

(57) ABSTRACT

A system for analyzing biological specimens by spectral imaging includes a biosensor comprising at least one graphene layer on a substrate and a memory in communication with a processor. The biosensor is configured to acquire a biological specimen sample. The memory and the processor are configured to conduct Raman spectroscopy to obtain spectral data for the sample, transmit the spectral data to a hub for direct or indirect transmission to one or more servers, perform multivariate analysis on the spectral data, and deliver a report based on the multivariate analysis of the spectral data.

### CROSS-REFERENCE TO RELATED APPLICATIONS

This application claims priority to U.S. Provisional Patent Application No. 63/194,794 filed on May 28, 2021, titled “System and Methods for Analyzing Biosensor Test Results,” the disclosure of which is incorporated herein, in its entirety, by this reference.

### FIELD

The described embodiments relate generally to sensors, and more particularly, to using Raman spectrometry to analyze biosensor test results.

### BACKGROUND

Biosensors may be used in life sciences, clinical diagnostics, environmental monitoring, and medical research for affinity-based sensing, such as hybridization between complementary single strand DNA in a microarray or affinity binding of a matched sensitive biological element-antigen pair. Biosensors may include a biological recognition element and a transducer that converts a recognition event into a measurable electronic signal. The electronic signal can be measured constantly or periodically during transient and/or steady state output.

Diagnosis requires more and more information about analytes present in biological samples, and there is an even greater need to routinely monitor multiple medically important biological species in rapid fashion. Accordingly, there remains a need for improved biosensors and analysis methods, particularly those that can provide more accurate and/or more rapid identification and concentration measurements and results.

### SUMMARY

Embodiments disclosed herein relate to methods of analyzing a sample. An example method includes acquiring a sample biological specimen with a biosensor. The biosensor can include at least one graphene layer on a substrate, the at least one graphene layer including one or more binding sites configured to bind or react with the sample biological specimen. The method can further include obtaining spectral data for the sample. In some embodiments, obtaining spectral data for the sample includes performing Raman spectroscopy. The method can include performing analysis on the spectral data and delivering a report based on the analysis of the spectral data.

In an embodiment, a method for analyzing a sample can include functionalizing at least some of the amount of graphene to form the one or more binding sites. The sample can include at least one of saliva and blood. In some embodiments, performing analysis on the spectral data includes aligning corresponding control points of the spectral data with data in a database that includes spectral images associated with a confirmed condition. In some embodiments, performing analysis on the spectral data includes performing analysis of the data via a machine-learning algorithm. In some embodiments, performing analysis on the spectral data includes selecting a region of a spectral image, comparing data for the selected region to data in a database that includes spectral images associated with a confirmed condition, determining any correlation between the data from the database and the data for the selected region, and classifying the selected region based on the determination.

In some embodiments, a method for analyzing a sample includes providing a diagnostic decision based on the analysis of the spectral data. The method can further include storing the spectral data in a database that includes spectral images associated with a confirmed condition.

In an embodiment, a system for analyzing biological specimens by spectral imaging is disclosed. The system can include a biosensor having at least one graphene layer disposed on a substrate. The biosensor can be configured to acquire a biological specimen sample. The system can further include a memory in communication with a processor. The memory and the processor can be configured to conduct Raman spectroscopy to obtain spectral data for the sample, transmit the spectral data to a hub for direct or indirect transmission to one or more servers, and deliver a report based on the multivariate analysis of the spectral data.

In some embodiments, the biosensor of the system for analyzing biological specimens by spectral imaging can include one or more binding sites configured to bind or react with the biological specimen sample. In some embodiments, the hub can be connected to the biosensor wirelessly. In some embodiments, the one or more servers can be configured to use pattern recognition to perform multivariate analysis on the spectral data. The pattern recognition can include aligning corresponding control points of the spectral data with data in a database that includes spectral images associated with a confirmed condition. The database can include the spectral data for the sample after the report is delivered. In some embodiments, the hub can include a model program configured to improve pattern recognition to analyze the spectral data.

In an embodiment, a method for analyzing the content of a biological sample can include contacting a biological sample with a biosensor including at least one graphene layer on a substrate. The graphene can be functionalized to include one or more binding sites specifically to at least one analyte in the sample to form one or more bound complexes. The method can further include generating Raman spectra from the bound complexes and detecting spectra data produced by the bound complexes. The spectra data associated with a bound analyte can be indicative of the presence and type of the analyte in the sample. The method can also include comparing the Raman signal associated with the bound analyte to a model, wherein the model includes Raman signals associated with a confirmed condition. In some embodiments, the method can also include providing a diagnostic decision based on the analysis of the spectra data.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a flow chart of a method for analyzing a sample, according to an embodiment.

FIG. 2 is a schematic cross-sectional view of a biosensor, according to an embodiment.

FIG. 3 is a schematic view of a system for analyzing biological specimens by spectral imaging, according to an embodiment.

FIG. 4 shows example Raman spectrographs for a graphene derived from coal, according to an embodiment.

FIG. 5 is a flow chart of a method for performing analysis on spectral data, according to an embodiment.

FIG. 6A shows example analysis on the spectral data by aligning corresponding control points of the spectral data with data in a database, according to an embodiment.

FIG. 6B shows example analysis on the spectral data by aligning corresponding control points of the spectral data with data in a database, according to an embodiment.

FIG. 7 is a flow chart of a method for analyzing the content of a biological sample, according to an embodiment.

### DETAILED DESCRIPTION

The present disclosure relates to methods of analyzing a sample, for example for use in acquiring a sample biological specimen with a biosensor, methods for analyzing the content of a biological sample, and related systems for analyzing biological specimens. An example method includes acquiring a sample biological specimen with a biosensor. The biosensor can include at least one graphene layer on a substrate. The at least one graphene layer can include one or more binding sites configured to bind or react with the sample biological specimen.

Conventionally, graphene formed using chemical vapor deposition (“CVD”) can be used in biosensors, for example as a substrate for a biosensor. Many studies have demonstrated that graphene produced by CVD, especially chemically modified graphene (“CMG”), can interface with individual whole cells, groups of cells, and biological components of cells. Graphene produced by CVD can be used as a biosensor thereby allowing for life science research, biomedicine, and personalized medicine to be carried out using relatively small-scale devices that can be highly affordable and transportable.

Disclosed herein are compositions, devices, methods, and systems useful in quickly and directly (or indirectly) detecting various analytes, markers, and biomarkers, for example detection of the causative agent of 2019 coronavirus disease (COVID-19), which can be referred to as severe acute respiratory syndrome coronavirus 2 (SARS-CoV-2). In many embodiments, the disclosed compositions, methods, devices, and systems are useful in detecting the causative agent and/or fragments thereof (e.g. virus particles and analytes and biomarkers derived therefrom), as well as immunoglobulins. The disclosed biosensor devices and analysis systems may be used at the POC to analyze samples from various sources, such as nasal swabs, saliva samples, blood samples, etc. The disclosed methods and systems can improve accuracy of the analysis of the analytes and improve diagnoses and treatment. Use of the disclosed systems can help to avoid the need to force patients and health care professionals to rely upon indirect measurements and analysis of a potentially infected patient via symptoms that may be associated with one or more other illnesses.

The proposed methods and systems are useful in various aspects of diagnosing, analyzing, and identifying one or more biomarkers associated with a virus or other condition and can include production of one or more components from graphene, for example, graphene from coal. In many cases, the disclosed technology can involve compositions and methods that improve functionalization of the graphene. Functionalization of graphene can include attaching one or more of an analyte, a capture probe, or combinations thereof. In some embodiments, a biosensor surface may be functionalized to recognize more than one specific probe, analyte, biomarker, etc. Thus, in many embodiments, the disclosed biosensor can detect and/or measure the presence of an infectious agent or antibodies thereto, such that the results may indicate an active or past infection.

The disclosed compositions, methods, devices, and systems provide for improved analysis of one or more markers/reagents/biomarkers associated with a disease or condition. In many cases, the sample, for example a sample derived from one or more of blood, mucus, saliva, nasal swab, etc. may be analyzed with the disclosed compositions, devices, methods, and systems in less than 60, 45, 30, or fewer minutes.

As used herein, the term “diagnosis,” “identification,” “analysis,” etc. may refer to an assessment of whether a subject or patient suffers from a disease or harbors an infective particle, or not. In some cases, the diagnosis may not be 100% correct, ether as to the presence or absence, or origin of the disease or infection, or to its severity. The term, however, refers to a statistically significant portion thereof, which may be determined by those of skill in the art, such as healthcare personnel, statisticians, technicians, etc. A diagnosis may also include a prognosis for the tested patient or subject.

The term “analyte,” “marker,” and “biomarker” may be used interchangeably to refer to a biological molecule, or a fragment of a biological molecule, the change and/or the detection of which can be correlated with a particular diagnosis, condition or state. Such biomarkers include, but are not limited to, viruses, viral particles, proteins, cytokines, hormones, biological molecules including nucleotides, nucleic acids, nucleosides, amino acids, sugars, fatty acids, steroids, metabolites, peptides, polypeptides, proteins, carbohydrates, lipids, hormones, antibodies, regions of interest that serve as surrogates for biological macromolecules and combinations thereof (e.g., glycoproteins, ribonucleoproteins, lipoproteins). Exemplary biomarkers may include proteins, peptides, peptide fragments, nucleic acid sequences, derived from COVID-19 and other infectious agents, and/or antibodies directed thereto. Thus, biomarkers may indicate an active infection or a past infection.

The terms “receptor,” “capture probe,” and/or “capture molecule” may refer to one or more molecules or compounds that may interact with an analyte to form a co-molecule or complex, or recognition pair. In many embodiments, the receptor or capture probe is an antibody specific for an analyte, or an epitope on the analyte. In many embodiments, two or more capture probes may bind to a given analyte, at the same or at different epitopes. If the epitopes recognized by a capture probe are different on the analyte, a “sandwich assay” may be used. The capture probe or receptor can be various compounds and molecules, including, without limitation, natural or synthetic single stranded or double stranded nucleic acids, proteins, peptides, nucleopeptides, antibodies, and/or antibody fragments.

The term “biosensor” may refer to any device, composition, or compound that may interact with one or more of the biomarkers in a way that may be recognized, recorded, or measured. In some cases, the biosensor may include one or more detection devices to monitor an interaction with a biomarker. The detection may be direct or indirect through a read out. In some embodiments, detection may be visual, chemical, electrical or other

The term “virus” may be used to describe various viral structures, particles, as well as components thereof, such as proteins and/or nucleic acids. In some embodiments, the virus may be intact or not intact, such as denatured or not yet fully formed, for example, when a host cell is disrupted to expose viral parts within the cell.

The term “patient” may refer to a human or non-human subject who is being treated, monitored, tested, or the like, in many cases for the presence of a condition, disease, or disorder, such as possible infection, for example by a virus. The test may be performed at home, at a nursing home, at a testing facility, at a hospital, at a bedside, at a triage center, etc. usually, by a healthcare professional.

The term “sample” may refer to any specimen or biospecimen obtained from a patient suspected or having or at risk of having, or developing a disease or condition. In many embodiments the biospecimen is obtained from a bodily fluid of the patient, such as blood, saliva, mucus, nasal secretion, tear, sweat, feces, urine, etc. In some embodiments, the biospecimen may be a tissue and/or cells from the patient.

The term “healthcare provider” may refer to a physician, for example a primary care, emergency, intensive care, pulmonary, infectious disease physician and others, as well as employees, affiliates, colleagues, assistants thereof, such as nurses, therapists, administrators, pharmacy personnel, technicians, lab technicians, etc.

The term “treatment” may refer to any procedure, protocol, or method that may aid in the prevention and/or amelioration of a disease, condition, or disorder referred to herein or its symptoms. Treatment may also refer to curing the disease or condition, and/or reestablishment of a healthy, pre-disease status or condition in the patient or subject with respect to the disease and/or its symptoms.

Binding affinity of various analyte-receptor combinations may vary. In some embodiments, the analyte-receptor may be an antibody-antigen combinations. Affinity for these interaction/combinations may affect sensitivity and specificity of the biosensor.

The graphene biosensors can be functionalized by decorating various surfaces with a receptor molecule, for example an antibody that is specific for the analyte. In some embodiments, the antibodies may be identified using a process that does not reduce the sensitivity of the graphene and does not interfere with the binding affinity of the chosen antibodies. In one embodiment, P bonding may be used to facilitate functionalization.

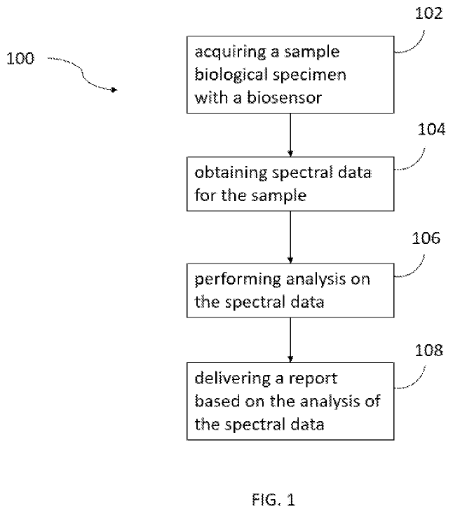

FIG. 1 is a flow chart of a method 100 for analyzing a sample biological specimen, for example saliva, according to some embodiments. As shown in FIG. 1, the method 100 includes acquiring a sample biological specimen with a biosensor at block 102. The method 100 also includes obtaining spectral data for the sample at block 104 and performing analysis on the spectral data at block 106. In some embodiments, the method 100 may also include delivering a report based on the analysis of the spectral data at block 108.

Block 102 includes acquiring a sample biological specimen with a biosensor. Such a specimen would be taken by sampling to be representative of any other specimen taken from the source of the specimen. Biological specimens such as blood, urine, saliva, and may other types may be collected for a variety of reasons, for normal patient monitoring and care as well as for basic, clinical, and epidemiological research. Many medical advances, including studies of cancer, pandemics, heart disease, etc. have resulted from preliminary developmental studies that have relied on access to and proper use of the appropriate specimens.

Block 102 includes a biosensor. An example biosensor may include at least one graphene layer on a substrate, the at least one graphene layer including one or more binding sites configured to bind or react with the sample biological specimen. An example biosensor is described below with reference to FIG. 2. However, biosensors may include any sensor that incorporates biological or biologically derived sensing elements that harness the site specificity and sensitivity of living systems in conjunction with electronic transducers and processors, to either provide data or to directly actuate an appropriate response.

After or concurrently with block 102, the method 100 may include functionalizing the graphene to attach or bond at least one functionalization group to the graphene. When the graphene is used in a biosensor, the functionalization groups may form all of at least one binding site of the biosensor or the functionalization groups may form a portion of the binding site (e.g., the binding site includes the functionalization group and a sensitive biological element). The binding site of the biosensor is configured to bind or otherwise react with at least one target that is to be detected (e.g., an analyte, virus, antibody to the virus, bacteria, etc.). When the graphene is used in a drug delivery system, the functionalization groups may form all of or at least a portion of the at least one binding site. The binding site of the drug delivery system may be configured to bind with or otherwise react with a selected organism (e.g., selected organ, cancerous cells, etc.) and/or the medicament. As previously discussed, impurities, such as hexavalent metals in the graphene may facilitate the functionalization of the graphene.

Examples of functionalization groups that may be bonded or added to the graphene include at least one of chromium tricarbonyl (Cr(CO)₃), molybdenum disulfide (MoS₂), hexagonal boron nitride (BN), transition metal dichalcogenides, an eta-6 ligand, for example including one or more heavy metals, oxi- and/or amine functionalization groups, or graphene quantum dots. The functionalization groups may be added to the graphene in any manner, as known in the art or as developed in the future.

In some examples, only a single functionalization group is attached to the graphene. In such an example, the graphene may only detect one target or a plurality of undistinguishable targets. In some examples, a plurality of functionalization groups (e.g., about 2 to about 6, about 4 to about 8, about 6 to about 10, about 8 to about 15, about 10 to about 20, about 15 to about 30, about 25 to about 50, about 40 to about 70, or about 60 to about 100), such as different functionalization groups, may be added to the graphene, such as to the same graphene flake. In such examples, the graphene may detect a plurality of targets simultaneously. In some examples, the graphene is separated into a plurality of different groups of graphene that each include at least one flake of graphene. Each of the different groups of graphene may be functionalized with different functionalization groups. There may or may not be overlap between the different groups of graphene and the different functionalization groups. After functionalization, the different groups of graphene may detect different targets. The different graphene groups may form a plurality of subsensors on an array, wherein at least some of the subsensors are configured to detect different targets.

In some examples, the graphene formed during block 104 is not functionalized. The graphene may not be functionalized when the impurities, folds, or wrinkles in the graphene already form functionalization groups or binding sites for targets, when the biological specimen may be attached directly to the graphene, or when the biosensor is evaluated using techniques that do not require functionalization groups (e.g., Raman based detection detects the target based on the chemical structure of the targets).

In an embodiment, the method 100 may include obtaining spectral data for the sample at block 104. Spectroscopic methods are advantageous in that they alert to slight changes in chemical composition in a sample biological specimen, which may indicate an early stage of disease. Additionally, spectroscopy allows review of a larger sample of tissue or cellular material in a shorter amount of time than it would take to visually inspect the same sample. Further, spectroscopy relies on instrument-based measurements that are objective, digitally recorded and stored, reproducible, and amenable to mathematical/statistical analysis. Thus, results derived from spectroscopic methods are more accurate and precise then those derived from other standard methods. Various techniques may be used to obtain spectral data. For example, obtaining spectral data for the sample can include performing Raman spectroscopy, which assesses the molecular vibrations of a system using a scattering effect, may be used. Raman spectroscopy works best using a tightly focused visible or near-IR laser beam for excitation. This, in turn, dictates the spot from which spectral information is being collected. This spot size may range from about 0.3 μm to 2 μm in size, depending on the numerical aperture of the microscope objective, and the wavelength of the laser utilized.

In an embodiment, the method 100 may include performing analysis on the spectral data at block 106. Raman spectroscopy is widely used in the investigation of biological specimens due to its high spatial resolution (typically in the range of 1 to 10 μm), large amount of obtainable information, non-destructivity and ability to perform in-situ analysis. In some embodiments, the method 100 may include delivering a report based on the analysis of the spectral data at block 108. The report may include a digital report or a printout. In some embodiments, the report may include text and/or data, or may further include spectral data. In some embodiments, the report may include a recommendation or a diagnostic decision, based on the analysis of the spectral data.

FIG. 2 is a schematic cross-sectional view of a biosensor 200, according to an embodiment. Biosensors are analytical devices that convert a biochemical/biological reaction into a measurable physio-chemical signal, which is proportional to the analyte concentration. The biosensor 200 may include a rapid diagnostic biosensor, a sequencing biosensor, a cancer detection biosensor, a biosensor configured for personalized medicine, an enzyme-linked immunosorbent assay reporter, or any other suitable biosensor. The biosensor 200 may detect many targets and/or biological samples, such as glucose, dopamine, D-serine, deoxynucleic acid hybridization, coronavirus 2019 (COVID-19) virus or antibodies for COVID-19 virus, severe acute respiratory syndrome coronavirus (SARS) and/or antibodies for the severe acute respiratory syndrome coronavirus, other coronaviruses and/or antibodies for the other viruses, coronaviruses, Zika virus, Borrelia burgdorferi and/or Borrelia mayonii (i.e., the bacteria that causes Lyme disease), influenza A virus, influenza B virus, protein biomarkers (e.g. folic acid protein, lysozyme, prostate-specific antigen) or other biomarkers. The biosensor 200 disclosed herein may be more sensitive, specific robust, hardy, as well as potentially offering usage in more applications than existing biosensors while also being cheaper than biosensors that included graphene formed using conventional methods and sources, such as a sandwich assay.

The biosensor 200 includes a substrate 202. The substrate 202 may include, for example, silica, silicon, a metal, or any other suitable material. In some embodiments, suitable substrates may include platinum, cobalt, nickel, copper, iron, iridium, gold, rubidium, rhenium, rhodium, germanium, and/or copper-nickel alloys. In other embodiments, suitable substrates may include silicon, silicon oxide, magnesium oxide, silicon dioxide, sapphire, h-BN, and/or silicon nitride. In yet other embodiments, bi-functional metals or trifunctional metals including copper germanium may be a suitable substrate. Copper and germanium may be included because of low solubility for carbon and an affinity for the formation of single layer graphene.

The substrate 202 may also include a single material (as shown) or may be formed from multiple layers (e.g., a base with at least one layer disposed thereon). At least one graphene layer 204 may be disposed on at least a portion of at least one surface of the substrate 202. In some examples, up to about 5 layers, 10 layers, 15 layers, 20 layers, can be disposed on the surface of the substrate 202. The graphene layer 204 may be disposed on the substrate 202 using any suitable method. For example, the graphene layer 204 may be disposed in a solution and the solution may be applied to the substrate 202 using a spin coating technique. One or more binding sites 206 configured to bind with or otherwise react with a target may be formed on the graphene layer 204. As previously discussed, the binding site 206 may be formed by at least one of functionalizing the graphene layer 204, attaching (i.e., directly or indirectly) one or more sensitive biological elements to the graphene layer 204, wrinkles or folds formed in the graphene layer 204, or impurities naturally present in the graphene layer 204. When the biosensor 200 includes a plurality of binding sites 206, each of the binding sites 206 may be the same or at least one of the binding sites 206 may differ from at least one other binding site 206.

In some embodiments, the biosensor 200 may also include a heater 208 configured to heat at least the substrate 202 and the graphene layer 204. In an embodiment, the heater 208 may cause the target that is bound or otherwise reacted with the binding sites 206 to be released from the binding sites 206 by heating the graphene layer 204 allowing the biosensor 200 to be reused. In some examples, when the target is DNA, heat from the heater 208 may cause the DNA to denature allowing the DNA to bind or react with the binding site 206 (e.g., the binding site 206 includes a single strand DNA).

In some examples, the biosensor 200 includes two or more electrical contacts 210 (e.g., electrodes or probes) contacting at least a portion of the graphene layer 204. The electrical contacts 210 may also contact the substrate 202. The electrical contacts 210 may be connected to an electrical sensor 212 via one or more wires or other electrical connections. The electrical sensor 212 may include any sensor configured to detect one or more electrical characteristics of the graphene layer 204. For example, the electrical sensor 212 may include a voltmeter, a current sensor, a multimeter, or any other sensor that can detect the electrical characteristics of the graphene layer 204. For example, the electrical properties of the graphene layer 204 may change after the graphene layer 204 is exposed to the sample. How the electrical properties of the graphene layer 204 changes depends at least partially on the binding site 206 and the particular biological specimen. For example, the electrical current may change (i.e., the biosensor 200 is an amperometric biosensor), medium conductance may change (i.e., the biosensor 200 is a conductometric biosensor), the potential or charge accumulation may change (i.e., the biosensor 200 is a potentiometric biosensor), the interfacial electrical impedance may change (i.e., the biosensor 200 is a impedimetric sensor), or the current or potential across a semiconductor channel may change (i.e., the biosensor 200 is a field-effect transistor).

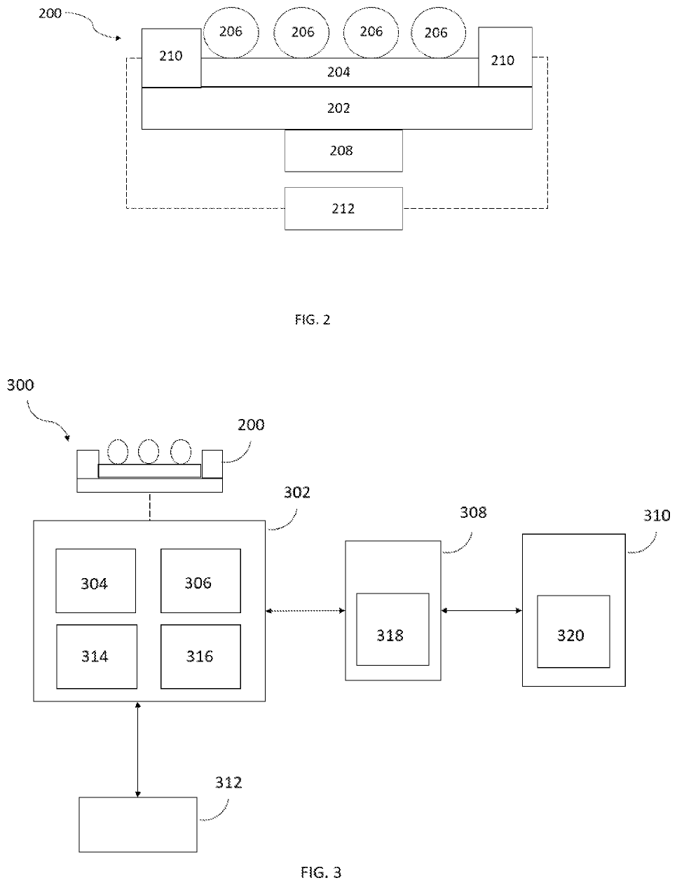

Referring now to FIG. 3, the biosensor 200 may be a portion of a system 300 for analyzing biological specimens by spectral imaging. The system may include electrical circuitry 302. In some examples, as shown, the electrical circuitry 302 is coupled to the electrical sensor 212 (e.g., via an input of the electrical circuitry 302). In some examples, the electrical circuitry 302 is integrally formed with the electrical sensor 212. Regardless, the electrical circuitry 302 is configured to receive one or more signals from the biosensor 200 via electrical sensor 212.

The signals from the electrical sensor 212 include the detected electrical properties of the graphene layer 204 and the electrical circuitry 302 is configured to analyze the detected electrical properties to determine if the target is present. For example, the electrical circuitry 302 includes at least one processor 304 and a memory 306 in communication with the processor 304. The memory 306 includes one or more operational instructions stored thereof and the processor 304 is configured to execute the operational instructions. The operational instructions, in conjunction with the signals received from the electrical sensor 212, allows the electrical circuitry 302 to determine the presence and/or quantity (e.g., concentration) of the biological specimen on the graphene layer 204. For example, with the operational instructions, the processor 304 may determine the presence and/or quantity of the specimen on the graphene layer 204 by determining that the detected electrical properties include a current change, a medium conductance change, a potential or charge accumulation change, an interfacial electrical impedance change, or a current or potential across semiconductor channel.

The memory 306 in communication with the processor 304 is configured to conduct Raman spectroscopy to obtain spectral data for the sample, transmit the spectral data to a hub 308 for direct or indirect transmission to one or more servers 310, and deliver a report 312 based on the multivariate analysis of the spectral data. The electric circuitry 302 may also include or be connected to an output device 314 that allows the electrical circuitry 302 to communicate with a patient or healthcare provider using the system 300 and also to communicate with the hub 308. The output device 314 may include a printer, a display, one or more lights, a tactile feedback device, or any other suitable output device. The electrical circuitry 302 may be configured, through the output device 314, to provide graphic and/or tabular information to the individual, a binary yes or a no that the target and/or sample is present or present over a certain quantity, the binding affinity (antibody/antigen) or mismatch of nucleic acids, the concentration of the biological specimen, or any other information. In an embodiment, the electrical circuitry 302 may also include or be connected to an input 316 that allows a user to provide commands to the electrical circuitry 302, such as instructions to analyze a sample, which information to provide through the output device 314, or information regarding the user. The input 316 may include a touch screen, a mouse, a keyboard, one or more buttons, or any other suitable input device.

The system 300 may include one or more components that are not shown. In some examples, the system 300 may include a housing that includes one or more components of the biosensor 200 disposed therein or thereon. The housing may be small enough to be easily held in a hand. In some examples, the system 300 may include one or more stimulus devices (e.g., ultraviolet light source) that are configured to provide a stimulus that causes the biological sample to be released from the binding sites. In some examples, the system 300 may include a power source, such as batteries or a plug that provides electrical power to one or more components (e.g., electrical sensor 212 and/or electrical circuitry 302) of the biosensor 200.

The hub 308 may be connected to electrical circuitry 302 and the biosensor 200 wirelessly. In the example shown in FIG. 3, a wireless hub 308 collects, aggregates, and stores data from the electrical circuitry 302 without the need for any reader infrastructure. The wireless hub 308 can then relay this data to the one or more servers 310, which may include a remote network. Alternatively, the system 300 can be operated in a wired configuration, or connected to the internet, transmitting the data out to the network. Also, the system 300 may include multiple hubs 308. For example, hubs 308 may be located in different rooms of a building.

In some embodiments, the hub 308 includes a model program 318. The model program 318 may be downloaded to the hub 308 from the one or more servers 310. The model program 318 can then be available locally and improve the results of the biosensor 200 provided in the report 312. As will be described in greater detail below, the model program 318 is configured to improve pattern recognition to analyze the spectral data. In an example, a machine learning algorithm incorporates prior knowledge into a suitable prior distribution of spectral data, which guides the analysis toward models that are relevant to the output of the biosensor 200.

The one or more servers 310 analyze the spectral data. In an embodiment, performing analysis on the spectral data includes performing analysis of the data via a machine-learning algorithm. Machine-learning methods are based on the similarity or variance in the spectral data, respectively, and segment or cluster a data set by these criteria, requiring no information except the data set for the segmentation or clustering. Thus, the machine learning methods can create spectral images that are based on the natural similarity or dissimilarity (variance) in the spectral data. In some embodiments, the server 310 includes a database that includes spectral data that is associated with specific conditions or biological specimens, among other things. The association of conditions to spectral data in the database 320 may be based on a correlation of the Raman spectroscopy to spectral patterns based on the Raman features normally found in specimens having known conditions. Thus, in some embodiments, performing analysis on the spectral data includes aligning corresponding control points of the spectral data with data in a database that includes spectral images associated with a confirmed condition. Using machine learning, the one or more servers can be configured to use pattern recognition to perform multivariate analysis on the spectral data. The spectral data that has been classified and/or annotated with a disease or condition, provides a reliable database that may be implemented for the machine learning.

In an example, with sufficiently reliable data compiled as a data set, the analysis method may provide a diagnostic algorithm. Once the spectral data has been registered, it may be used make a medical diagnosis. The diagnosis may include the presence of a disease or a condition including, but not limited to, a virus, infections, cancer, etc. In a method according to aspects of the invention, spectral data from a spectral image of a biological specimen of unknown disease or condition that has been submitted and/or detected with the biosensor 200 may be input to database 320, as described above. Based on similarities to the samples of the database 320, the spectral data of the biological specimen may be correlated to a disease or condition. The disease or condition may be output as a diagnosis. For example, spectral data may be acquired from a biological specimen of unknown disease or condition. The spectral data may be analyzed by machine learning, which may then be used along with reference data from the database to prepare the report 312. This report 312 and the spectral data from the biological specimen sample may be registered and added to the database. The spectral data that has been analyzed by machine learning may then be included in the database or data set and used for later analysis and diagnosis.

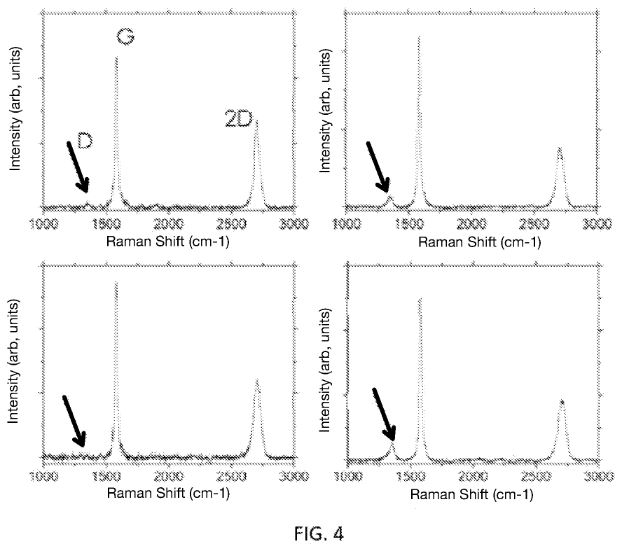

FIG. 4 shows Raman spectrographs of a sensor including graphene formed from coal according to the methods described herein. The Raman spectrographs shown in FIG. 4 were generated using samples of graphene formed by a CVD process using a coal-derived carbon source. The arrows in the graphs of FIG. 4 indicate the location of the “D band” of graphene. Generally, the “D band” of graphene in Raman spectrographs are associated with defect states in the graphene structure. The graphs of FIG. 4 illustrate that the “D band” is non-existent or minimal indicating that the graphene exhibits substantially no undesirable defects. The graphs illustrated in FIG. 4 may be baselines to determine if the biosensor 200 includes a desired level of impurities, the biological specimen sample, or any other additional components. For example, Raman spectrographs that differ significantly from the graphs illustrated in FIG. 4 (e.g., including additional peaks and/or a change in the relative heights of the peaks) may indicate the sample type, as described herein.

FIG. 5 is a flow chart of a method 400 for performing analysis on spectral data, according to an embodiment. As shown in FIG. 5, the method 400 includes selecting a region of a spectral image at block 402. The method 400 also includes comparing data for the selected region to data in a database or data set that includes spectral images associated with a confirmed condition at block 404, and determining any correlation between the data from the database and the data for the selected region at block 406. In some embodiments, the method 400 may also include classifying the selected region based on the determination at block 408.

At block 402, a region of the spectral image may be considered a region of interest. Raman spectroscopy is classified as vibrational spectroscopy. Raman spectroscopy is based on Raman scattering (or Raman effect) that reveals the vibrational, rotational and other low frequency modes of molecules. In this technique, the sample is exposed to an intense beam of monochromatic light (typically a laser beam) in the frequency range of visible, near-infrared or near-ultraviolet region. The electromagnetic radiation, interacting with a substance, can be transmitted, absorbed, or scattered. When the monochromatic radiation is scattered by molecules, the majority of the radiation undergoes the common “Rayleigh” scattering (radiation's frequency/wavelength is unchanged). However, a small fraction of the scattered radiation is observed to have a slightly different frequency from that of the incident radiation. The frequency shifts are virtually independent of the excitation wavelength and are characteristic of the particular substance/molecule. Usually one only records the relatively strong “Stokes” lines, which therefore are attributed a positive frequency shift. Such spectral coordinate is called the Raman shift and measured in wavenumbers (in cm⁻¹). In Raman spectroscopy, as it is a scattering technique, samples are simply placed in the laser beam and the scattered radiation is collected and analyzed. Raman spectrometer measures the wavelength-dependent intensity of the in-elastically scattered light.

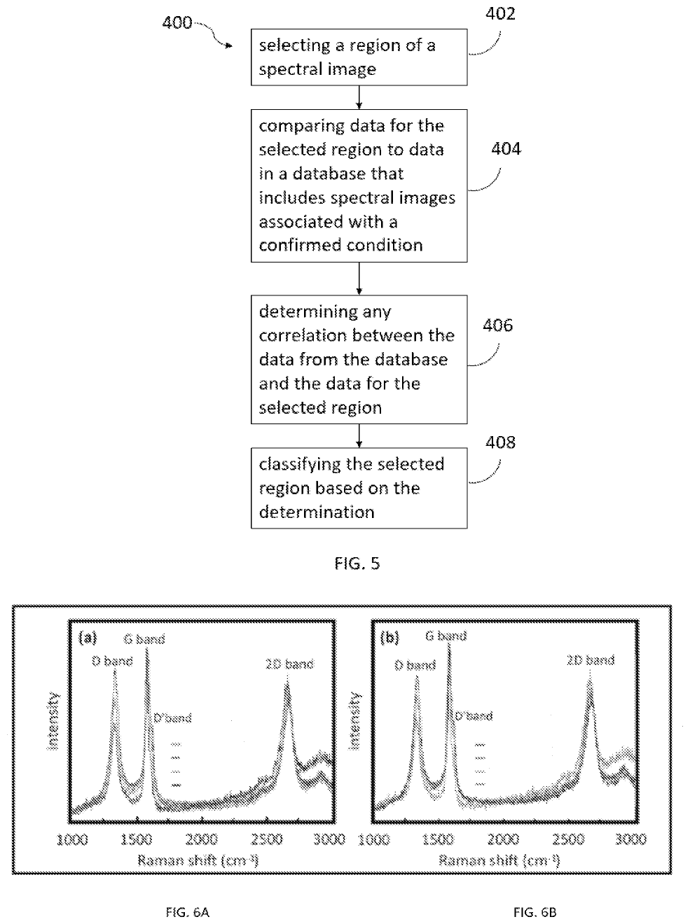

FIGS. 6A-6B show example Raman spectrographs and show an example of how the system 300 may perform analysis on the spectral data, such as describe in block 404 of FIG. 5. The graph shown in FIGS. 6A-6B include overlapping spectra data including a first spectra that can indicate the biological specimen sample and at least one other set of spectral data from the database 320 or the model program 318. Typically, a Raman spectrum is a distinct chemical fingerprint for a particular biological specimen and can be used to identify the specimen and distinguish it from others. The accuracy of the analysis is based on the usefulness of the database or spectral library, defined in part by how accurate it is and how much known about a biological specimen. The database must contain structures similar to the specimen in order to be useful. The critical decision to be made is whether the measured spectral data can be considered consistent with the reference spectral data in the data set. Machine learning may improve the database and the reference spectral data over time. The method 400 may further include storing the spectral data from the biological sample in the database that includes spectral images associated with a confirmed condition. Almost all organic, and many inorganic, species have Raman bands. A complex spectrum can represent either a complex molecule with a wide range of functional groups or multiple components. The database 320 can improve over multiple samples and can update the model program 318 of the hub 308.

In some embodiments, the one or more servers are configured to use pattern recognition to perform multivariate analysis on the spectral data. The pattern recognition includes aligning corresponding control points of the spectral data with data in a database that includes spectral images associated with a confirmed condition. In some embodiments, the method 400 may further include providing a diagnostic decision based on the analysis of the spectral data. Again, the diagnostic decision can be more accurate as the analysis of the spectral data improves with the addition of data and the machine-learning algorithm becomes more accurate. In some embodiments, the database 320 can be updated to include the spectral data for a given biological sample after the report 312 is delivered.

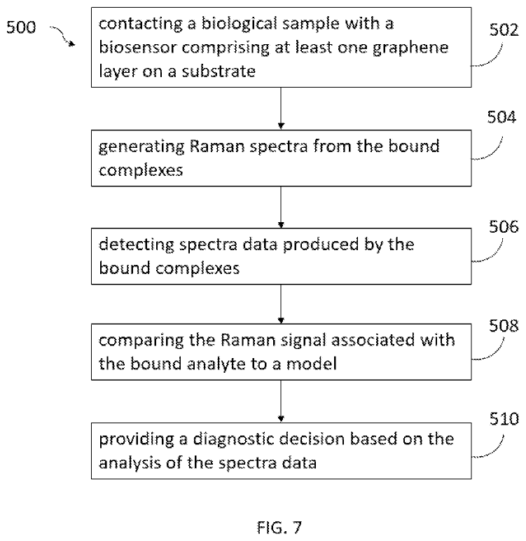

FIG. 7 is a flow chart of a method 500 for analyzing the content of a biological sample, according to an embodiment. In an embodiment, the method 500 may include contacting a biological sample with a biosensor including at least one graphene layer on a substrate at block 502. The graphene may be functionalized to include one or more binding sites specifically to at least one analyte in the sample to form one or more bound complexes. The method 500 may further include generating Raman spectra from the bound complexes at block 504. Accurate vibrational analysis requires optimizing the molecular structure and wave functions in order to obtain the minimum energy state of the molecule. In practice, this requires selection of a suitable basis set method for the electron correlation. The selection of the basis set and parameters is important in acquiring acceptable calculated vibrational data necessary to assign experimental Raman spectra.

The method 500 may also include detecting spectra data produced by the bound complexes at block 506. The spectra data associated with a bound analyte is indicative of the presence and type of the analyte in the sample. Any quantitative analyses involve measurement of a test sample and comparison with standards of known concentration. In some embodiments, the spectral data can be analyzed by point mapping to bring an image into alignment with another image. In point mapping, control points on both of the data sets of the reference data and the biological specimen to identify the same feature or landmark in the comparative data are selected. Based on the positions of the control points, spatial mapping of both images can be performed. For example, at least two control points may be used. The system 300 may select the control points based on data of distinguishing features developed by machine learning of the spectral images including, but not limited to, peaks and/or boundaries.

In some embodiments, the method 500 can also include comparing the Raman signal associated with the bound analyte to a model at block 508. The model can include Raman signals associated with a confirmed condition. The analysis may detect at least one control point that corresponds to a distinguishing feature in the visual or spectral images. For example, control points in a particular a cluster region may be selected in the spectral image. The cluster pattern may be used to identify similar features in the visual image. The features in both images may be aligned by translation, rotation, and scaling. Translation, rotation, and scaling may also be automated or semi-automated, for example, by developing mapping relationships or models after selecting the features selection. Such an automated process may provide an approximation of mapping relationships that may then be resampled and transformed to optimize the analysis.

In some embodiments, the method 500 can also include providing a diagnostic decision based on the analysis of the spectra data at block 510. The diagnosis may include a binary output, such as an “is/is not” type output, that indicates the presence or lack of a disease or condition. In addition, the diagnosis may include, but is not limited to an adjunctive report, such as a probability of a match to a disease or condition, an index, or a relative composition ratio. According to an example method, a healthcare provider may include certain inputs to ensure that an accurate diagnosis is achieved. For example, the healthcare provider may visually check the quality of the spectra data. In addition, the healthcare provider may perform adjust the analysis at the hub 308 or at the electrical circuitry to ensure proper modeling and/or change the selection of the region of the spectral image. The method may be performed by a pathologist viewing the biological specimen and performing the analysis. Alternatively, since the registered image contains digital data that may be transmitted electronically, the method may be performed remotely.

The methods and biosensor disclosed herein are disclosed as involving graphene.

However, it is noted that the methods and biosensor disclosed herein may involve graphene oxide (“GO”) and/or carbon nanodots (e.g., GO nanodots or graphene nanodots) instead of or in conjunction with graphene, without limitation. For example, some methods disclosed herein to form graphene may also form GO and/or carbon nanodots from coal instead of or in conjunction with graphene depending on the extraction techniques and the parameters of the extraction techniques. These GO and/or carbon nanodots derived from coal may be used in the life science devices instead of or in conjunction with the graphene since these GO and carbon nanodots derived from coal may be made from a cheap source (i.e., coal), may include beneficial impurities (i.e., hexavalent metals), and exhibit beneficial electrical and thermal properties.

For example, the biosensors disclosed herein may include GO layers, carbon nanodot layers, a combination thereof, or a combination of graphene and GO and/or nanodots. Regardless of whether these layers include graphene, GO, carbon nanodots, or a combination thereof, the layers of the biosensor may be functionalized and/or sensitive biological elements may be attached to these layers and the biosensor may be used as disclosed herein. Examples of GO quantum dots that may form biosensors are disclosed in Sukhyun Kang et al., Graphene Oxide Quantum Dots Derived from Coal for Bioimaging: Facile and Green Approach, 9 Sci Rep 4101 (2019), the disclosure of which is incorporated herein by reference, in its entirety.

Various disclosures have been described herein with reference to certain specific embodiments and examples. However, they can be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

The foregoing description, for purposes of explanation, used specific nomenclature to provide a thorough understanding of the described embodiments. However, it can be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It can be apparent to one of ordinary skill in the art that many modifications and variations are possible in view of the above teachings.

What is claimed is:

1. A method for analyzing a sample biological specimen, the method comprising:
acquiring the sample biological specimen with a biosensor;
obtaining spectral data for the sample;
performing analysis on the spectral data; and
delivering a report based on an analysis of the spectral data.

2. The method of claim 1, wherein the biosensor comprises at least one graphene layer on a substrate, the at least one graphene layer comprising a binding site configured to bind or react with the sample biological specimen.

3. The method of claim 2, further comprising functionalizing at least a portion of the at least one graphene layer to form the binding site.

4. The method of claim 1, wherein obtaining spectral data for the sample includes performing Raman spectroscopy.

5. The method of claim 1, wherein the sample comprises at least one of saliva and blood.

6. The method of claim 1, wherein performing analysis on the spectral data comprises aligning corresponding control points of the spectral data with data in a database that includes spectral images associated with a confirmed condition.

7. The method of claim 1, wherein performing analysis on the spectral data comprises performing analysis of the data via a machine-learning algorithm.

8. The method of claim 6, wherein performing analysis on the spectral data comprises:
selecting a region of a spectral image;
comparing data for the selected region to data in a database that includes spectral images associated with the confirmed condition;
determining a correlation between the data in the database and the data for the selected region; and
classifying the selected region based on the determination.

9. The method of claim 1, further comprising providing a diagnostic decision based on the analysis of the spectral data.

10. The method of claim 1, further comprising storing the spectral data in a database that includes spectral images associated with a confirmed condition.

11. A system for analyzing a biological specimen by spectral imaging, comprising:
a biosensor comprising at least one graphene layer on a substrate, wherein the biosensor is configured to acquire a biological specimen sample;
a processor; and
a memory in communication with the processor, wherein the memory and the processor are configured to:
conduct Raman spectroscopy to obtain spectral data for the sample;
transmit the spectral data to a hub for direct or indirect transmission to one or more servers; and
deliver a report based on a multivariate analysis of the spectral data.

12. The system of claim 11, wherein the biosensor comprises a binding site configured to bind or react with the biological specimen sample.

13. The system of claim 11, wherein the hub is connected to the biosensor wirelessly.

14. The system of claim 13, wherein the one or more servers are configured to use pattern recognition to perform multivariate analysis on the spectral data.

15. The system of claim 14, wherein the pattern recognition comprises aligning corresponding control points of the spectral data with data in a database that includes spectral images associated with a confirmed condition.

16. The system of claim 15, wherein the database includes the spectral data for the sample after the report is delivered.

17. The system of claim 11, wherein the hub includes a model program configured to improve pattern recognition to analyze the spectral data.

18. A method for analyzing content of a biological sample, comprising:
contacting a biological sample with a biosensor comprising at least one graphene layer on a substrate, wherein the graphene is functionalized to include a binding site specifically to at least one analyte in the sample to form a bound complex;
generating Raman spectra from the bound complex; and
detecting spectra data produced by the bound complex, wherein the spectra data associated with a bound analyte is indicative of the presence and type of analyte in the sample.

19. The method of claim 18, further comprising:
comparing a Raman signal associated with the bound analyte to a model;
wherein the model includes a Raman signal associated with a confirmed condition.

20. The method of claim 18, further comprising providing a diagnostic decision based on an analysis of the spectra data.
